(19) United States
(12) Patent Application Publication
(10) Pub. No.: US 2008/0191941 A1
(43) Pub. Date: Aug. 14, 2008

(54) INDOOR LOCATION DETERMINATION

(75) Inventors: Ofer Saban, Belt Elazari (IL); ISAAC SHAPIRA, Petach Tikva (IL); Yehuda Holtzman, Mazkeret-Batia (IL); Yair Shapira, Shoham (IL); Yair Oren, Washington, DC (US)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: MobileAccess Networks Ltd., Lod (IL)

(21) Appl. No.: 12/028,842

(22) Filed: Feb. 11, 2008

Related U.S. Application Data
(60) Provisional application No. 60/889,306, filed on Feb. 12, 2007.

(51) Int. Cl. G01S 3/00

(52) U.S. Cl. 342/450

(57) ABSTRACT

A tentative location of a transmitter in an indoor environment is determined by triangulation, using at least two direction finders. The tentative location is made more accurate by performing at least one added action selected from the following: checking the likelihood that the tentative location is an accurate location by comparing measured transmitter signal strengths with calculated signal strengths, using a known indoor environment structure, using a record of the transmitter movement through the indoor environment for determining whether the transmitter is located in an obscured area of the indoor environment or performing an alignment procedure on the antennas to improve the triangulation.

### CROSS REFERENCE TO RELATED APPLICATIONS

This application claims the benefit of U.S. Provisional Patent Application No. 60/889,306 filed Feb. 12, 2007, which is incorporated herein by reference in its entirety.

### FIELD OF THE INVENTION

The invention relates generally to location identification and more particularly to indoor location identification of devices such as transmitting transmitters or cellular phones or any other hand held devices with ability to transmit radio signals. From now on such devices will be called “transmitters”.

### BACKGROUND OF THE INVENTION

Location based services for providing services based on location of transmitters are expanding rapidly. Herein, “location” refers to the location of a transmitter described by coordinates or by textual description. “Location determination” refers to the process of determining the location of the transmitter.

Several technologies have been proposed for outdoor location identification, including Time Difference of Arrival (TDOA) and GPS. These technologies are flawed in terms of their ability to locate indoor subscribers with required reliability and accuracy. Large steel and concrete buildings such as hospitals, warehouses, airport terminals and malls may be difficult or even impossible to cover using TDOA, GPS and other outdoor location identification technologies. Low signal levels and signal multipath effects in these environments decrease the location identification accuracy or totally prevent signal acquisition.

Multi-floor buildings pose additional obstacles for indoor location identification, as they require three-dimensional location determination. Even if the longitude and latitude of an individual transmitter were known with great accuracy, that knowledge would be insufficient, since no knowledge is provided on the specific floor where the transmitter resides. As a result, new indoor location technologies systems have begun to appear on the market, addressing the special conditions and requirements of the indoor environment. The need for such systems stems from a variety of market segments and applications. Respective market segments include healthcare, warehouse, industry, etc. Applications include various types of asset location (e.g. medical equipment in a hospital) and human location (e.g. patients or medical staff in a hospital).

A known indoor location system typically consists of a set of fixed receivers and a set of wireless transmitters attached to persons or assets of interest. An antenna set, given its reference location grid, is used to locate the transmitter set. Several location technologies are used in the market for indoor location. These include TDOA, TOA (Time of Arrival) and RSS (Received Signal Strength) measurements. The main drawback of these technologies is their inability to properly cope with reflection and shadowing of the transmitted signals, typical to indoor environments. This limits the accuracy of the location determination to an average error level of about 5 meters and to errors higher than about 10 meters in more than 10% of the cases. For many current and future location based applications, these error levels are unacceptable.

Therefore, there is a need for and it would be advantageous to have a system that provides positioning of transmitters in indoor environments with higher accuracy than that of current systems.

### SUMMARY OF THE INVENTION

We disclose indoor location identification systems and methods that improve significantly the accuracy of the location determination of indoor transmitters. Methods provided in various embodiments enable to accurately locate the position of a transmitter within a building while overcoming some of the common issues related to indoor radio propagation, like reception of significant reflections of the transmitted signal and high attenuation created by obstructions like walls and metal objects.

A system used in the invention includes multiple receivers used as direction finders installed in a building in a way that most of the area of the building is covered by at least two receivers. A tentative location of an indoor transmitter is determined using an “Angle of Arrival (AOA) triangulation” procedure where each of the directions towards the transmitter is found by an AOA technique. Each receiver includes at least one group of at least three antennas. Each receiver processes the signal arriving from the at least three antennas (as explained below) and identifies the direction (angle) of the transmission. In itself, this processing cannot yield an accurate indoor location identification. Therefore, the AOA triangulation determined tentative location is improved and made accurate by use of at least one added input, which may include:
a) Use of the signal strength of the signals received by at least two receivers for invalidating wrong results out of a set of possible results.
b) Use of “knowledge” on the structure of the building and/or use of history of movements of transmitters in the building, accumulated continuously and recorded in a database of the system, for invalidating wrong results out of a set of possible results and, in some cases, for providing an educated guess on the location of the transmitter
c) Use of a procedure to overcome errors due to misalignment of the antennas. According to this procedure, the relative position of each antenna is measured and compared to a designed position. The difference between the actual position and the designed position is found and stored to be used as a correction factor in the transmitter location calculation process.

In general, the AOA triangulation may be used in combination with any one added input or combination of added inputs.

In some embodiments, there is provided a method for determining an indoor location of a transmitter, including the steps of: a) inside an indoor environment, performing an AOA triangulation procedure on the transmitter to provide a tentative indoor transmitter location; and b) using at least one added input to ensure that the tentative transmitter location is an accurate indoor transmitter location. In some embodiments, the step of performing an AOA triangulation includes using at least two direction finders to perform the triangulation, wherein each direction finder includes at least one array of three antennas. In some embodiments, an added input may include measured phase differences of signals obtained by different antenna pairs in each antenna array to overcome errors induced by reflections; a comparison of a measured strength of a signal received from the transmitter with a calculated strength expected from the tentative location; a known indoor environment structure used to eliminate unlikely tentative locations; a record of the transmitter movement through the indoor environment to eliminate unlikely tentative locations; and an alignment procedure performed on the antennas to improve the AOA triangulation. In some embodiments, two or more added inputs may be combined with the AOA triangulation to increase the accuracy of the indoor transmitter location determination.

In some embodiments, there is provided a method for determining a location of a transmitter, comprising the steps of: a) inside an indoor environment, performing an AOA triangulation procedure on the transmitter to provide a tentative indoor transmitter location; b) calculating a signal strength expected from the respective transmitter; c) comparing the calculated signal strength with a measured signal strength of the respective transmitter to obtain a correlation value; d) comparing the correlation value with a threshold; e) based on the comparison, determining if the tentative indoor transmitter location is an accurate location. If the correlation value is equal to or higher than the threshold, the tentative location is determined to be the accurate location. If the correlation value is lower than the threshold, the tentative location is not the accurate location, and the method further comprises the step of using an added input to determine the accurate transmitter location. The added input includes using a combination of at least two actions selected from the group consisting of using a known indoor environment structure to eliminate unlikely tentative locations, using a record of the transmitter movement through the indoor environment to eliminate unlikely tentative locations and performing an alignment procedure on the antennas to improve the AOA triangulation.

A more complete understanding of the invention, as well as further features and advantages of the invention will be apparent from the following detailed description and the accompanying drawings.

### BRIEF DESCRIPTION OF THE DRAWINGS

The invention is herein described, by way of example only, with reference to the accompanying drawings, wherein:

FIG. 1 shows an embodiment of an indoor location identification system used in the invention;

FIG. 2 shows an array of 3 co-located antennas used to find the direction of a transmitted signal;

FIG. 3 shows a possible implementation of direction finding using a phase shifter;

FIG. 4 shows the performance of null steering approach with and without reflection;

FIG. 5 shows a possible scenario where false location determination occurs due to reflections;

FIG. 6 shows the flow chart of the algorithm used to avoid false location determination, using signal strength criteria;

FIG. 7 shows a second possible scenario where false location determination occurs due to reflections;

FIG. 8 shows a situation where additional error may be added due to misalignment of the antenna array.

### DETAILED DESCRIPTION OF THE INVENTION

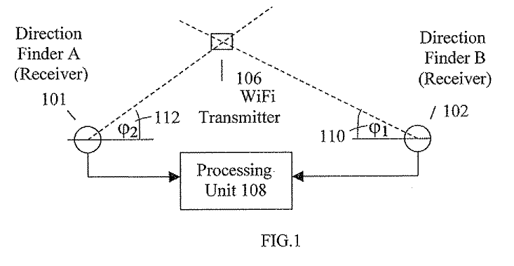

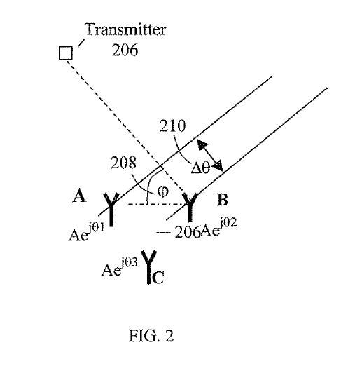

FIG. 1 shows an embodiment of an indoor location identification system used in the invention. The system includes a first receiver used as direction finder A 101 and a second direction finder B 102, both being antenna arrays of which principle of operation is explained below. Each direction finder includes at least one array of at least three antennas A, B, C (see FIG. 2) and receives from a transmitter 106 a beam (“pointer”) at an angle (p relative to the line between the two receivers. A processing unit 108 coupled to each direction finder receives from each direction finder the respective φ angle. The tentative location of the transmitter can be found based on angles φ1 and φ2 and prior knowledge of the location of the direction finders 101 and 102 (“triangulation”). However, the basic direction finding based on angle of arrival has almost never been applied to indoor environments, and when applied has not been successful, because of the reflections and other artifacts common to such environments. In the invention, correction algorithms described in detail below are therefore applied to the information provided by the receivers. It is the application of these algorithms that provides the required enhanced location determination accuracy of a transmitter in an indoor environment.

In use, the processing unit performs “null scanning” to find the direction of the transmission. Null scanning techniques are known but, as far as the inventors could determine, have never been used for indoor location. An exemplary “null scanning” process is explained next, with reference to FIG. 2. FIG. 2 shows a basic direction finder with at least one array of three antennas (A, B, C) arranged as shown. In some embodiments, the antennas are arranged at apexes of an equilateral triangle. The direction of the transmitter is determined by calculation of the angle φ based on measurement of a phase difference Δθ between the phases of signals received by antenna A and antenna B. Since antennas A and B are very close to each other (exemplarily less than 5% relative to their distance from the transmitter) in the absence of reflections the amplitude of the signal received in both antennas is equal. Angle φ can then be calculated from Δθ, as explained below.

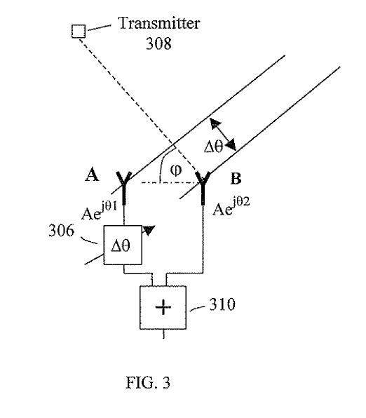

Another way to look at this approach is depicted in FIG. 3. In this figure the signal transmitted by a transmitter 308 and received by antenna A is fed to a phase shifter 306 in processing unit 108. The output of phase shifter 306 and the signal received in antenna B are summed together in a combiner 310 also included in the processing unit. To find φ the phase shifter is varied until the signal at the output of combiner 310 is null. When a null is achieved, the value of Δθ represents the phase difference between the signals received in antenna A and antenna B. Angle φ can then be calculated from Δθ according to the following equation cos φ=dθλ/(2πd) where λ is the wavelength of the signal and d is the distance between antenna A and B.

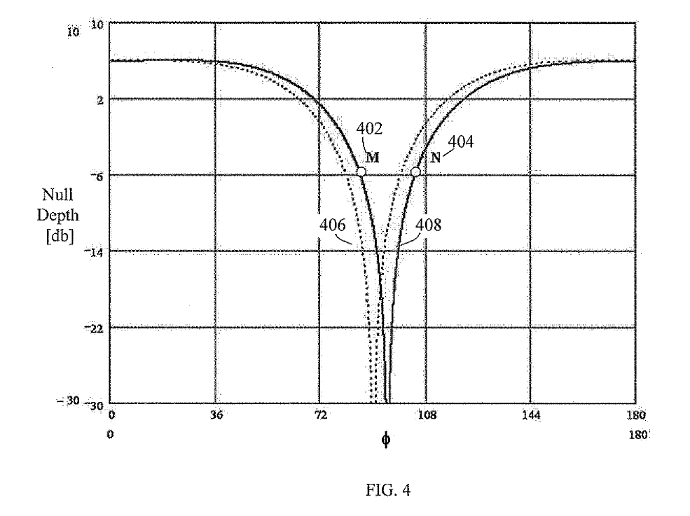

The relative signal at the output of combiner 310 as a function of Δθ is graphically described by solid line 408 in FIG. 4. As can be seen from the graph, based on null finding, an array of two elements can point the direction with a very high resolution, theoretically with a “beam width” of zero degrees. This is in contrast with techniques which are based on directing a beam with a maximum gain towards the transmitter (e.g. “beam-forming”) where the beam width (in other words: the accuracy of the detection) achieved with two antenna elements is about 15 degrees, as well known in the art.

When searching for null in an indoor environment, the accuracy of the measurement deteriorates when getting closer to the null. This is mainly due to reflections and due to the fact that the summed signal reaches a low level that can not be measured accurately. To overcome this problem, instead of trying to get to the lowest possible level of the summed signal (the null), two measurements can be done at a relatively high signal level, for example at a level where the gap between point M 402 and point N 404 is 10 degrees (FIG. 4). Since the null function is symmetrical, the direction of the transmitter is in the middle between the angles found in point M 402 and N 404. This procedure is also known in the art.

As stated above, a major problem in receiving signals in an indoor environment is the strong reflections component from walls, floor and ceiling. The reflection component received in antennas A and B adds a signal component that may result in a deviation of the calculated direction. The dotted graph 406 in FIG. 4 shows the deviation of the calculated direction due to a reflection arriving at an angle of 45 degrees relative to the direct ray and having a magnitude of −10 db lower than the direct ray. The graph was achieved using a simulation.

In order to cope with the error introduced by the reflection, the invention makes use of antenna element C. By measuring and calculating the phase differences between antenna pairs A-C and B-C, it is possible to provide two additional equations for calculating the direction of the transmitter. If all three measurements (obtained by antenna pairs A-B, A-C and B-C) provide the same direction, it can be concluded that the result is not impacted by reflections. If the results are not identical, it is possible to average the three directions or calculate the direction based on the solution of electromagnetic (EM) equations based on the signal vectors V1, V2 and V3 received by antenna elements A, B and C, which are well known in the art of direction finding engineering. The rough direction found by averaging the directions found by antenna pairs A-B, A-C, B-C can be used as “initial condition” for the solution of the EM equations.

The radio waves that propagate from the transmitter may arrive to the receiving antenna arrays through reflections, diffractions and scattering mechanisms. In addition, at some points, a significant shadowing may attenuate the signals in their way to the antenna arrays, thus creating a situation where the system can not identify the location of the transmitter with the required accuracy. In some cases, due to reflections, the system may even identify a completely wrong location. In order to minimize these occurrences, the inventors have determined that the structure of the building, e.g. the location of the external and internal walls, and the strength of the signals received in the direction finder, can be used as an additional input in order to avoid false detection and further improve the location determination accuracy.

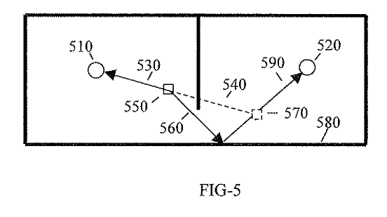

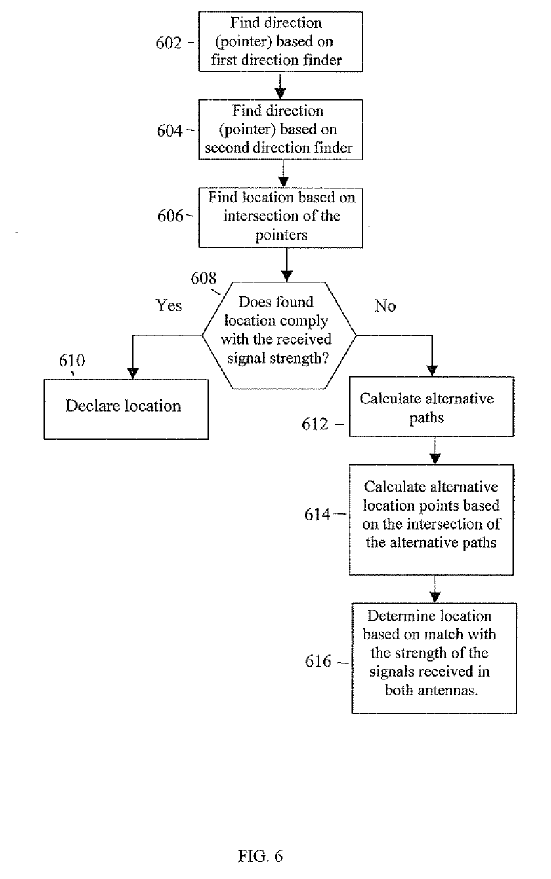

FIG. 5 demonstrates how the location determination may be further improved based on received signal strength. Assume a situation where there is no line of sight between a transmitter 502 and a direction finder 520. In this case, the strongest signal arriving at direction finder 520 may be the result of a reflection of a ray 560 hitting a wall 580 and being reflected towards direction finder 520 as a ray 590. Based on the direction of reflected ray 590 (found by direction finder 520) and on the direction of ray 530 (found by direction finder 510) processing unit 108 may (wrongly) conclude that the tentative location of the transmitter is at a point 570 (where the pointers of the direction finders intersect). To avoid this type of error, processing unit 108 also considers the strength of the signal received at each direction finder and checks whether this signal strength can be received from the suspected location 570. In the example above, the signal strength of transmitter 502, received in antenna array 510, may be too high for tentative location 570. For example, assume that the algorithm has calculated that location 570 is 6 meters from direction finder 510 and 2 meters from direction finder 520. As a result of the last calculation, the signal received in direction finder 520 is expected to be higher than the signal received in direction finder 510 but since the actual location of the transmitter is in location 550 which is much closer to 510 than to 520, the actual signal received in direction finder 510 will be significantly higher than the signal received in antenna 520. Based on these discrepancies between the actual received signal strength and the suspected location, the system decides that the transmitter is not located in suspected location 570. Knowing the location of wall 580 will help processing unit 108 to find the actual location of the transmitter. The flow chart of the decision process is described in FIG. 6.

The process starts with steps 602 and 604 where the direction of the transmitter is found by at least two direction finders. Then, in step 606, the tentative location of the transmitter is calculated by AOA triangulation of the two directions found in steps 602 and 604. Step 608 checks whether the strength of the signals received in both direction finders matches the suspected location. If the suspected location matches with the strengths of the signals received in both direction finders, with a correlation level above a certain configurable threshold, then step 610 of the algorithm “declares” the tentative location as actual location. If the correlation level of the suspected location does not match the strengths of the signals above the threshold level, the algorithm concludes that the suspected location is a result of at least one reflection. Then, in step 612, knowledge on the structure of the building is used to calculate an alternative ray path based on reflection from the walls. For example, according to FIG. 5, ray 590 continues backward until it hits wall 580 and reflects back until it intersects with ray 530. In step 614, a calculation of the alternative location as the intersection point of calculated ray 560 and ray 530 is performed. A correlation between alternative location 530 and the strength of the signals received in both direction finders 510 and 520 is checked in step 616. If the correlation level is above a threshold, (a configurable parameter) the algorithm “declares” the alternative location as the accurate (true) location.

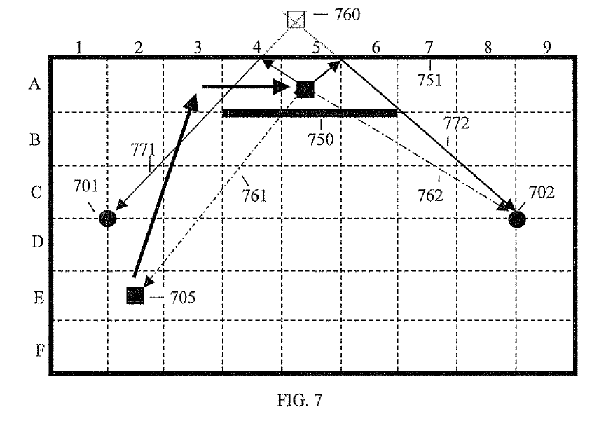

Another input that may further improve the accuracy of the location identification is based on combination of the “knowledge” on the structure of the building and history of the movements of transmitters in the building, accumulated continuously and recorded in the data base of the system. Each location is recorded with a certainty level index, which is a function of a) a correlation level between the determined location and the relative signal strengths, received by the direction finders, and b) the strength of signals used for the location determination (the higher is the signal strength, higher is the certainty level). The following exemplary scenario, described with reference to FIG. 7, explains how the knowledge of the structure of the building and the history of the locations of transmitters in the building are used to improve location determination accuracy.

In FIG. 7, the layout of a building is divided into rectangular grid of “area units”, each area unit defined (as in maps) by a letter and a number, for example A1, A2 . . . etc. Hereinafter, area units will be identified by their letter and number. Assume transmitter 705 is moving from E2 towards A5. Direction finders 701 and 702 track its route with a high level of certainty until it arrives in A3. Since the transmitter is in line of sight with the direction finders for the entire path from E2 to A3, the location at each point on the path is determined with a high level of certainty. When the transmitter enters the corridor and stays, for example, in A5, the direct rays 761 and 762, transmitted from the transmitter to direction finders 701 and 702 are highly attenuated by a wall 750. On the other hand, strong reflected waves 771 and 772, incident from a wall 751, are also received at the antennas. Based on the reception of the reflected waves, the system determines wrongly that the transmitter is located at position 760 (outside of the building).

However, since the system also “knows” the location of wall 751 and knows that 751 is a perimeter wall, it will conclude that location 760 (known to be located outside of the building) is a “false identification”. Since prior to the “false identification” of the transmitter, the transmitter was identified with a high level of certainty in area units A3 and A4 by “knowing” (from the building plan) that A4, A5 and A6 form a corridor, the system concludes that the transmitter is located in that corridor either in A5 or in A6. Further, based on history of location records designated with certainty level, the system knows that if a transmitter is located in A6, its location can be identified with a high level of certainty. Since the transmitter was not identified in A6, the system concludes that the transmitter is located in area unit A5.

The algorithm and decision mechanisms described above may be implemented by a software program (algorithm), which receives as inputs the following parameters: (a) the direction to the transmitter as obtained by the direction finders, (b) the signal strength of the signals used for determining the direction to the transmitter, (c) the structure of the building, and (d) history of location records per area unit having a respective “certainty level”. The implementation of such an algorithm in code would be clear to one skilled in the art.

### Overcoming Inaccuracies Due to Misalignment of the Antennas

The center of an antenna can be accurately positioned on a predetermined mapped spot. However the orientation of the antenna may diverge by a few degrees relative to the original design. The radial deviation of the antenna array from its reference orientation may be measured. The same system used for the location (direction finders, processing unit, etc.) can be used for “self calibration” in order to eliminate errors due to misalignment. This contributes to the overall accuracy of the system.

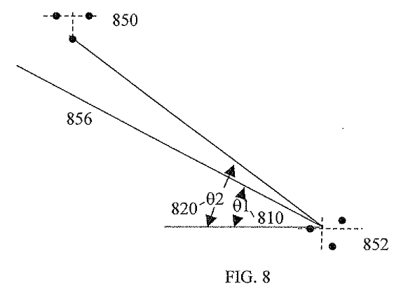

The following explanation refers to FIG. 8. The “self calibration” method for overcoming inaccuracies due to misalignment of the antennas is based on transmitting a signal from a neighboring antenna array 850 and receiving this signal by a newly installed antenna array 852. Due to a misalignment of antenna array 852, the resulting angle will be θ1 810 instead of a designed angle θ2 820. The deviation between θ2 820 and θ1 810 reflects a radial deviation of antenna array 852. This deviation may be stored in a database of the system and can be used as a correction factor in direction measurements. The self calibration may be done once, before start of transmitter location determination measurements, or may be done at any other time between transmitter location determination measurements.

While the invention has been described with respect to a limited number of embodiments, it will be appreciated that many variations, modifications and other applications of the invention may be made. What has been described above is merely illustrative of the application of the principles of the present invention. Those skilled in the art can implement other arrangements and methods without departing from the spirit and scope of the present invention.

What is claimed is:

1. A method for determining an indoor location of a transmitter, comprising the steps of:
a) inside an indoor environment, performing an angle of arrival (AOA) triangulation procedure on the transmitter to provide a tentative indoor transmitter location; and
b) using at least one added input to ensure that the tentative transmitter location is an accurate indoor transmitter location.

2. The method of claim 1, wherein the step of performing an AOA triangulation procedure includes using at least two direction finders to perform the triangulation procedure.

3. The method of claim 2, wherein the using at least two direction finders to perform the triangulation procedure includes performing null scanning.

4. The method of claim 2, wherein each direction finder includes at least one array of three antennas wherein the step of using at least one added input includes using phase differences of signals obtained by different antenna pairs in each antenna array to overcome errors induced by reflections.

5. The method of claim 1, wherein the step of using at least one input includes comparing a measured strength of a signal received from the transmitter with a calculated strength expected from the tentative location.

6. The method of claim 1, wherein the step of using at least one input includes using a known indoor environment structure to eliminate unlikely tentative locations.

7. The method of claim 1, wherein the step of using at least one added input includes using a record of the transmitter movement through the indoor environment to eliminate unlikely tentative locations.

8. The method of claim 7, wherein the using a record of the transmitter movement through the indoor environment to eliminate unlikely tentative locations includes tracking the movement of the transmitter, and, based on the tracking, determining whether the transmitter is located in an obscured area of the indoor environment.

9. The method of claim 8, wherein the determining includes comparing tracking information with information obtained from a certainty level database and deciding that the transmitter is located in the obscured area if it is not in locations where it can be determined with a high certainly level.

10. The method of claim 7, wherein the using a record of the transmitter movement through the indoor environment to eliminate unlikely tentative locations includes using the record to exclude tentative outdoor transmitter locations.

11. The method of claim 1, wherein the step of using at least one added input includes performing an alignment procedure on the antennas to improve the AOA triangulation.

12. The method of claim 1, wherein the performing of the alignment procedure includes performing a self calibration procedure.

13. The method of claim 2, wherein the step of using at least one added input includes using a combination of at least two actions selected from the group consisting of comparing a measured strength of a signal received from the transmitter with a calculated strength expected from the tentative location, using a known indoor environment structure to eliminate unlikely tentative locations, using a record of the transmitter movement through the indoor environment to eliminate unlikely tentative locations and performing an alignment procedure on the antennas to improve the AOA triangulation.

14. A method for determining a location of a transmitter, comprising the steps of:
a) inside an indoor environment, performing an angle of arrival (AOA) triangulation procedure on the transmitter to provide a tentative indoor transmitter location;
b) calculating a signal strength expected from the respective transmitter;
c) comparing the calculated signal strength with a measured signal strength of the respective transmitter to obtain a correlation value;
d) comparing the correlation value with a threshold;
e) based on the comparison, determining if the tentative indoor transmitter location is an accurate location.

15. The method of claim 14, wherein, if the correlation value is equal to or higher than the threshold, the step of determining includes determining that the tentative location is the accurate location.

16. The method of claim 14, wherein, if the correlation value is lower than the threshold, the step of determining includes determining that the tentative location is not the accurate location, and wherein the method further comprises the step of using an added input to determine the accurate transmitter location.

17. The method of claim 14, wherein the step of using an added input includes using a combination of at least two actions selected from the group consisting of using a known indoor environment structure to eliminate unlikely tentative locations, using a record of the transmitter movement through the indoor environment to eliminate unlikely tentative locations and performing an alignment procedure on the antennas to improve the AOA triangulation.

18. The method of claim 17, wherein the using a record of the transmitter movement through the indoor environment to eliminate unlikely tentative locations includes tracking the movement of the transmitter, and, based on the tracking, determining whether the transmitter is located in an obscured area of the indoor environment.

19. The method of claim 18, wherein the determining includes comparing tracking information with information obtained from a certainty level database and deciding that the transmitter is located in the obscured area if it is not in locations where it can be determined with a high certainly level.

20. The method of claim 17, wherein the using a record of the transmitter movement through the indoor environment to eliminate unlikely tentative locations includes using the record to exclude tentative outdoor transmitter locations.
